(19) United States
(12) Patent Application Publication
(10) Pub. No.: US 2025/0360884 A1
(43) Pub. Date: Nov. 27, 2025

(54) BATTERY COOLING DUCT FOR VEHICLES

(71) Applicants: Hyundai Motor Company, Seoul (KR); Kia Corporation

(72) Inventor: Bum Jin KIM, Hwaseong-si (KR)

(21) Appl. No.: 18/889,146

(22) Filed: Sep. 18, 2024

(30) Foreign Application Priority Data
May 23, 2024 (KR) 10-2024-0066893

(51) Int. Cl. B60R 13/08; B60K 11/08; H01M 10/613; H01M 10/625; H01M 10/6561; H01M 50/249

(52) U.S. Cl. CPC B60R 13/0846; B60K 11/08; B60R 13/0815; H01M 10/613; H01M 10/625; H01M 10/6561; H01M 50/249; H01M 2220/20

(57) ABSTRACT

A battery cooling duct for vehicles includes a battery case mounted on a center floor panel of a vehicle, an inlet duct configured such that cooling air from an interior of the vehicle is drawn into a first area of the battery case therethrough, and an outlet duct divided into a plurality of noise reduction parts including an expansion section and configured such that the cooling air introduced into the first area passes through a second area of the battery case and is discharged outside through the plurality of noise reduction parts.

### CROSS-REFERENCE TO RELATED APPLICATION

This application claims under 35 U.S.C. § 119 (a) the benefit of priority to Korean Patent Application No. 10-2024-0066893, filed on May 23, 2024, the entire contents of which are incorporated herein by reference.

### TECHNICAL FIELD

The present disclosure relates to a battery cooling duct for vehicles. More particularly, it relates to a battery cooling duct for vehicles that may improve marketability by applying a multi-noise reduction structure.

### BACKGROUND

Eco-friendly vehicles may use high-voltage batteries (e.g., hybrid electric vehicles are driven by a combination of internal combustion engines and batteries), while internal combustion engine vehicles are driven 100% by mechanical power. The eco-friendly vehicles may include a large number of high-voltage parts.

For instance, the case of high-voltage parts may include batteries, and performance differences occur depending on a temperature, and thus an appropriate temperature may be maintained.

In some cases, heat may continue to be generated in high-voltage parts when a vehicle is driven. If the high-voltage parts are not cooled separately, the high-voltage parts may be damaged or malfunction due to overheating, and there may be a risk of failure.

In some cases, a cooling system may allow the high-voltage parts to maintain an appropriate temperature to achieve the efficiency.

Particularly, cooling of batteries is important because eco-friendly vehicles are driven by batteries, and since batteries usually operate with optimal efficiency at a temperature between 20° C. and 40° C., it is important to maintain the corresponding temperature.

In some cases, where a separate air cooling system is mounted in the vehicle, the structure of the vehicle may become complicated, and additional costs may be incurred.

In some cases, the temperature of the interior of the vehicle may be controlled by a driver. For example, the interior air of the vehicle is generally maintained at a temperature of 20° C. to 40° C., at which humans feel comfortable.

Since the interior air of the vehicle, which is maintained within a certain range, has an optimal temperature for battery cooling, a method of cooling the battery using the interior air of the vehicle may be used without any separate air conditioning system.

For example, an inlet of a cooling device may be located below the side surface of a rear seat of a vehicle and draw in air from the interior of the vehicle and transfer the air to a battery through a passage extending to the battery. Here, since the passage extends from the side surface of the rear seat to the battery mounted under a trunk through the center of the rear seat, a curved part of the passage may occur, and the length of the passage may become longer and thus cause a complicated structure.

In some cases, air pressure loss may increase due to the extended length of the passage, which may reduce cooling efficiency and make airflow noise when air passes through a small cross-sectional area at a high speed, cooling fan noise, and noise caused by resonance/vibration of a duct.

### SUMMARY

The present disclosure describes a battery cooling duct for vehicles.

For example, the battery cooling duct may include a battery cooling passage, through which interior air is introduced and discharged, extends to form a plurality of noise reduction sections in an outlet duct, a first noise reduction section connecting the plurality of noise reduction sections to a cooling fan has a plurality of protrusions having a hemispherical shape, a second noise reduction section located under a first-row seat has an expanded cross-sectional area, a third noise reduction section located in the passenger space of a second-row seat is formed in the shape of a corrugated pipe, and a fourth noise reduction section extending from the third noise reduction section to discharge air is formed in a structure including a distributed head, so as to apply a multi-noise reduction structure to the outlet duct forming the battery cooling passage through the extended first to fourth noise reduction sections, and thus to improve marketability of the outlet duct.

According to one aspect of the subjected matter described in the present application, a battery cooling duct for vehicles includes a battery case mounted on a center floor panel of a vehicle, an inlet duct configured such that cooling air from an interior of the vehicle is drawn into a first area of the battery case therethrough, and an outlet duct divided into a plurality of noise reduction parts including an expansion section and configured such that the cooling air introduced into the first area passes through a second area of the battery case and is discharged outside through the plurality of noise reduction parts.

In some implementations, the plurality of noise reduction parts may include a first noise reduction part connected to the inlet duct and configured to reduce collision noise of the cooling air flowing into the first noise reduction part, a second noise reduction part configured to block mid/low-frequency noise propagation by selectively expanding a cross-sectional area to form the expansion section, a third noise reduction part configured to reduce noise in a frequency band determined by structural characteristics of wrinkles, including a shape, period, and height of the wrinkles, by blocking the noise through an acoustic bandgap phenomenon, and a fourth noise reduction part including a head member configured to distribute a discharge direction and discharge flow rate of the cooling air, and one or more of the first to fourth noise reduction parts may be connected.

In some implementations, the first noise reduction part may be formed at a position configured to face a connection area with the inlet duct, and a plurality of protruding members provided in a hemispherical shape may be continuously disposed on the first noise reduction part.

In some implementations, the first noise reduction part may be located in a passenger space of a first-row seat.

In some implementations, the second noise reduction part may extend from the first noise reduction part to selectively expand a cross-sectional area under the first-row seat.

In some implementations, the third noise reduction part may be located in a passenger space of a second-row seat.

In some implementations, the wrinkles of the third noise reduction part may be formed on a pair of surfaces configured to face each other inside the outlet duct.

In some implementations, the third noise reduction part may be formed such that a cross-sectional area thereof is repeatedly expanded and contracted in a flow direction of the cooling air.

In some implementations, the third noise reduction part may be formed such that the structural characteristics of the wrinkles are variable.

In some implementations, the fourth noise reduction part may be formed to have a large cross-sectional area relative to the third noise reduction part.

In some implementations, the head member may be coupled to a cooling air outlet formed at an end of the fourth noise reduction part.

In some implementations, the head member may allow the cooling air to be discharged in a distributed manner through a plurality of discharge parts continuously disposed along an edge of the cooling air outlet.

In some implementations, as the head member has a plurality of curved parts, the plurality of discharge parts may be formed between the plurality of curved parts, respectively, to discharge the cooling air in the distributed manner.

In some implementations, as the outlet duct extends in a direction away from the battery case while forming the plurality of noise reduction parts, one end of the outlet duct configured to discharge the cooling air outside therethrough may be disposed at a farthest position from the inlet duct.

According to another aspect, a battery cooling duct for vehicles includes a battery case mounted on a center floor panel of a vehicle, an inlet duct configured such that cooling air from an interior of the vehicle is drawn into a first area of the battery case therethrough, and an outlet duct divided into a plurality of noise reduction parts including a wrinkle section and configured such that the cooling air introduced into the first area passes through a second area of the battery case and is discharged outside through the plurality of noise reduction parts.

In some implementations, the plurality of noise reduction parts may include a first noise reduction part connected to the inlet duct and configured to reduce collision noise of the cooling air flowing into the first noise reduction part, a second noise reduction part configured to block mid/low-frequency noise propagation by selectively expanding a cross-sectional area to form an expansion section, a third noise reduction part configured to reduce noise in a frequency band determined by structural characteristics of wrinkles, including a shape, period, and height of the wrinkles, by blocking the noise through an acoustic bandgap phenomenon, and a fourth noise reduction part including a head member configured to distribute a discharge direction and discharge flow rate of the cooling air, and one or more of the first to fourth noise reduction parts may be connected.

In some implementations, the third noise reduction part may be located in a passenger space of a second-row seat.

In some implementations, the wrinkles of the third noise reduction part may be formed on a pair of surfaces configured to face each other inside the outlet duct.

In some implementations, the third noise reduction part may be formed such that the structural characteristics of the wrinkles are variable.

In some implementations, as the outlet duct extends in a direction away from the battery case while forming the plurality of noise reduction parts, one end of the outlet duct configured to discharge the cooling air outside therethrough may be disposed at a farthest position from the inlet duct.

Other aspects and example implementations of the disclosure are discussed infra.

The above and other features of the disclosure are discussed infra.

### BRIEF DESCRIPTION OF THE DRAWINGS

The above and other features of the present disclosure will now be described in detail with reference to certain exemplary implementations thereof illustrated in the accompanying drawings which are given hereinbelow by way of illustration only, and thus are not limitative of the present disclosure.

FIG. 1 is a view showing an example of a battery cooling duct for vehicles.

FIG. 2 is a view showing an example of an outlet duct of the battery cooling duct for vehicles.

FIG. 3 is a view showing an example of an outlet duct of the battery cooling duct for vehicles.

FIG. 4A is a view showing an example of a first noise reduction part of the battery cooling duct for vehicles.

FIG. 4B is a view showing an example of a first noise reduction part of the battery cooling duct for vehicles.

FIG. 5 is a view showing an example of a second noise reduction part of the battery cooling duct for vehicles.

FIG. 6A is a view showing an example of a third noise reduction part of the battery cooling duct for vehicles.

FIG. 6B is a view showing an example of a third noise reduction part of the battery cooling duct for vehicles.

FIG. 6C is a view showing an example of a third noise reduction part of the battery cooling duct for vehicles.

FIG. 7A is a view showing an example of a fourth noise reduction part of the battery cooling duct for vehicles, and

FIG. 7B is a view showing an example of a fourth noise reduction part of the battery cooling duct for vehicles.

In the figures, reference numbers refer to the same or equivalent parts of the present disclosure throughout the several figures of the drawing.

### DETAILED DESCRIPTION

Hereinafter, reference will now be made in detail to various implementations of the present disclosure, examples of which are illustrated in the accompanying drawings and described below.

Advantages and features of the present disclosure and methods for achieving them will become apparent from the descriptions of implementations hereinbelow with reference to the accompanying drawings.

However, the present disclosure is not limited to the implementations disclosed herein and may be implemented in various different forms. The implementations are provided to make the description of the present disclosure thorough and to fully convey the scope of the present disclosure to those skilled in the art. It is to be noted that the scope of the present disclosure is defined only by the claims.

In the following description of the present disclosure, a detailed description of known functions and configurations incorporated herein will be omitted when it may make the subject matter of the present disclosure rather unclear.

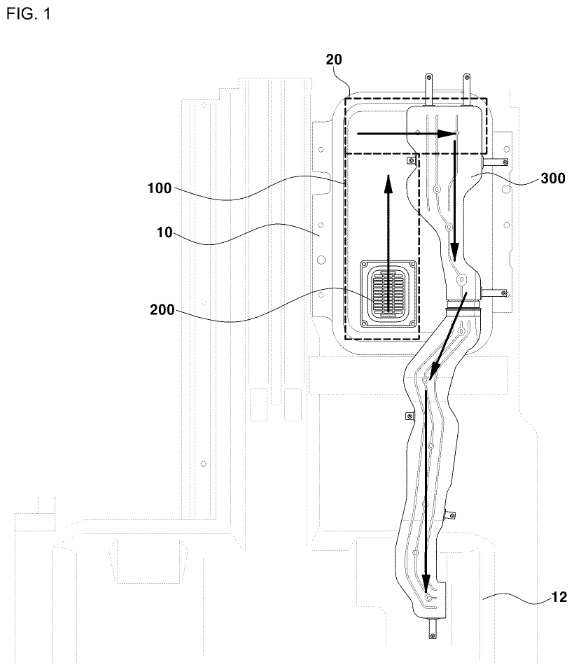

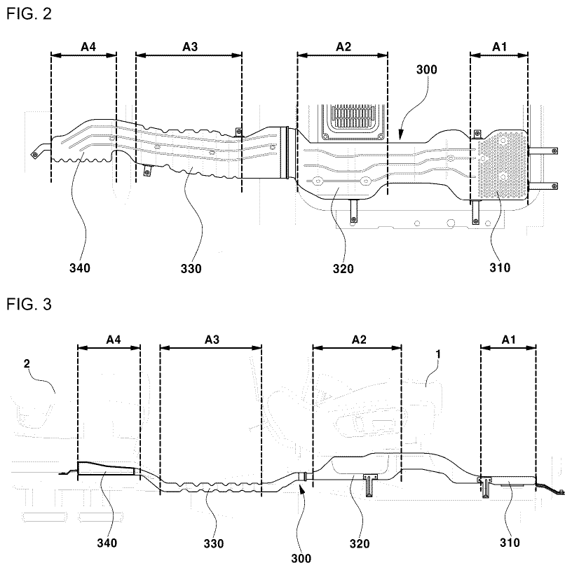

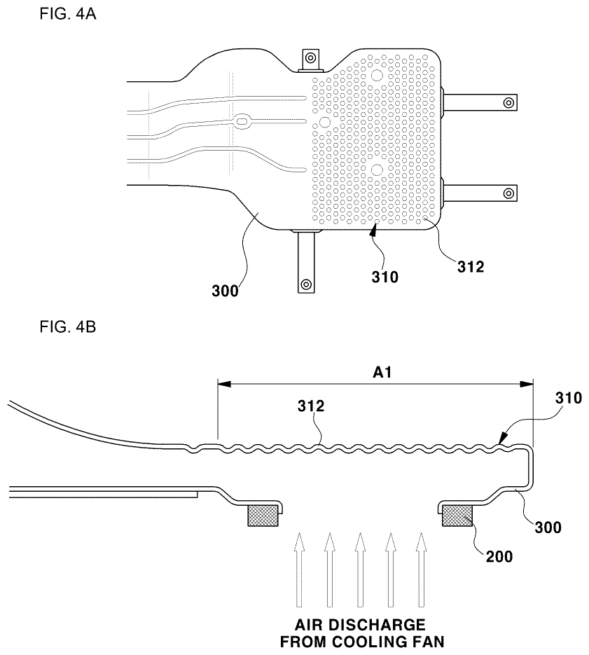

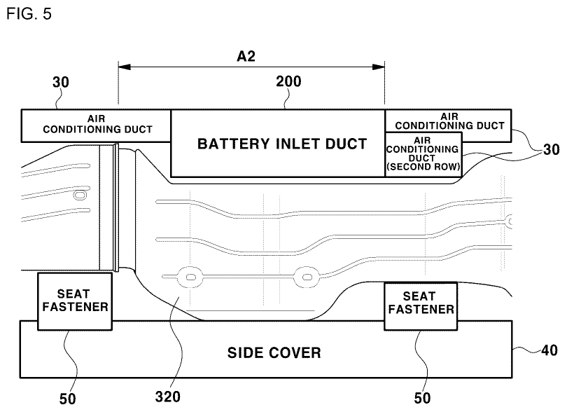

FIG. 1 is a view showing a battery cooling duct for vehicles, FIGS. 2 and 3 are views showing an outlet duct of the battery cooling duct for vehicles, and FIGS. 4A and 4B are views showing a first noise reduction part of the battery cooling duct for vehicles.

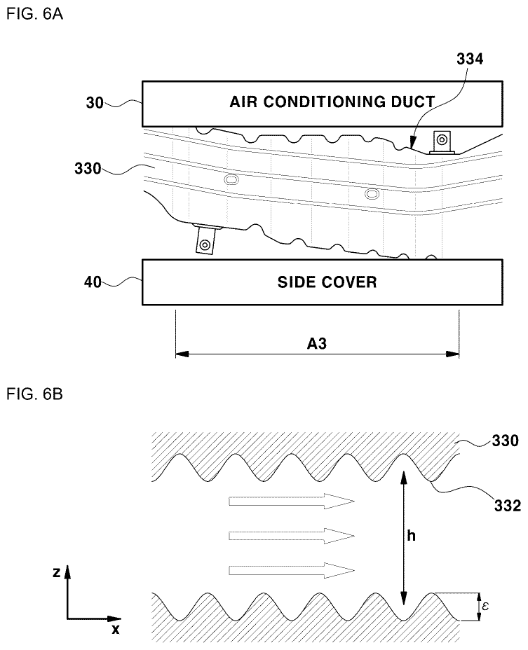

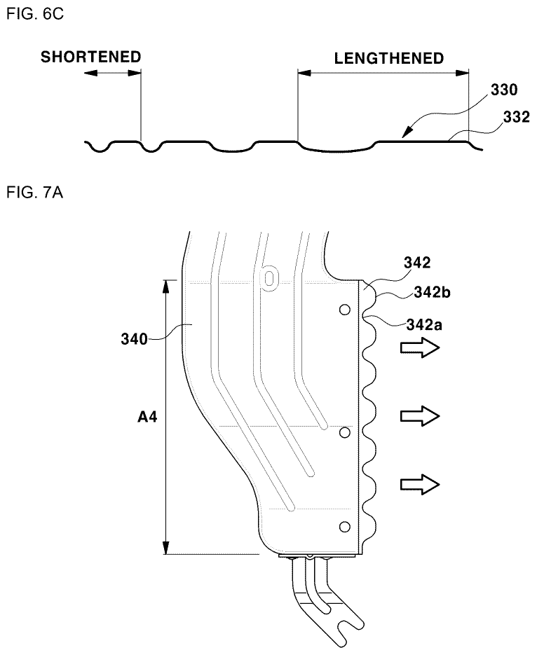

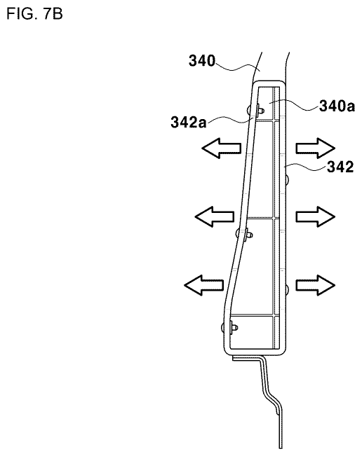

In addition, FIG. 5 is a view showing a second noise reduction part of the battery cooling duct for vehicles, FIG. 6A to 6C are views showing a third noise reduction part of the battery cooling duct for vehicles, and FIGS. 7A and 7B are views showing a fourth noise reduction part of the battery cooling duct for vehicles.

In some examples, the mounting positions of batteries are classified depending on the specifications and structures of vehicles. For example, in the case of a hybrid electric vehicle, in order to mount batteries having a relatively large volume, the batteries may be mainly mounted in the tire wells of a trunk, behind or under a second-row seat, under a first-row seat, and/or the like.

As a cooling method of the batteries mounted in this way, a battery system is usually cooled through natural cooling or forced cooling, and thereamong, forced cooling may be divided into a water-cooled type and an air-cooled type.

For example, an air-cooled forced cooling type battery system located under a first-row seat cools batteries using the interior air of a vehicle through an inlet duct structure, and discharges air to a second-row seat or a third-row seat through an outlet duct structure, and in this case, noise from a cooling fan of the battery system and airflow noise may occur along the path of an extended outlet duct.

That is, as the batteries, especially a battery pack assembly (BPA), is disposed in the center of the vehicle to ensure crash performance, an inlet duct connected to the battery pack assembly is also located in the center of the vehicle, an outlet duct is located in the side part of the vehicle to avoid the inlet duct and air conditioning ducts of the vehicle, and the outlet duct may inevitably have a long structure since a discharge area is an area around a third-row seat.

In some implementations, since the outlet duct should avoid various related parts, such as floor members, the air conditioning ducts, electrical equipment, etc., it is difficult to secure a space for positioning the outlet duct, and thus the outlet duct may have a complicated shape.

Consequently, the conventional outlet duct has a long length and a complicated shape, as described above, and thus, various noises occur. Particularly, airflow noise caused when air passes through a small cross-sectional area at a high speed, cooling fan noise, and noise caused by resonance/vibration of the outlet duct may occur.

In order to solve this noise problem, a battery cooling duct for vehicles includes a battery case 100, an inlet duct 200, and an outlet duct 300, as shown in FIG. 1.

In some examples, the battery case 100 can be mounted on a center floor panel 10 located in the center of a vehicle.

The inlet duct 200 is configured such that cooling air from the interior of the vehicle is drawn into a first area of the battery case 100 therethrough.

The outlet duct 300 is configured such that, as a cooling fan 20 provided in the inlet duct 200 is driven, the cooling air introduced into the first area passes through a second area of the battery case 100 and is discharged to the outside through noise reduction parts 310, 320, 330, and 340.

Here, the first area may be set to the front end of the battery case 100 (see FIG. 1), but is not limited thereto, and the second area is an area through which the cooling air in the first area passes as the cooling fan 20 is driven, and may be set to an area where the cooling fan 20 and the first noise reduction part 310, which will be described later, are connected, but is not limited thereto.

As shown in FIGS. 2 and 3, the outlet duct 300 is configured such that the plurality of noise reduction parts 310, 320, 330, and 340 including an expansion section is formed to be divided from each other in the lengthwise direction, and extends toward a rear floor panel 12, thereby allowing the cooling air having passed through the battery case 100 to be discharged to the outside, specially to the side surface portion of the second-row or third-row seat (see FIG. 1).

More particularly, as the outlet duct 300 extends in a direction away from the battery case 100 while forming the plurality of noise reduction parts 310, 320, 330, and 340, one end of the outlet duct 300 configured to discharge the cooling air to the outside therethrough, i.e., a fourth noise reduction part 340, which will be described later, is disposed at the farthest position from the inlet duct 200.

This is that, because air discharged from the outlet duct 300 is in a high temperature state, as the outlet duct 300 extends to form the plurality of noise reduction parts 310, 320, 330, and 340, noise is reduced by the extended length of the outlet duct 300, and the discharged air in the high-temperature state is disposed at the farthest position from the inlet duct 200, into which cooling air is introduced, to prevent cooling performance from being deteriorated due to the discharged air in the high-temperature state.

The outlet duct 300 has the first noise reduction part 310, a second noise reduction part 320, a third noise reduction part 330, and the fourth noise reduction part 340.

The first noise reduction part 310 is connected to the inlet duct 200, and reduces collision noise of cooling air introduced into the first noise reduction part 310.

Here, the first noise reduction part 310 is formed at a position facing a connection area with the inlet duct 200, and a plurality of protruding members 312 provided in a hemispherical shape is continuously arranged along a first noise reduction section A1.

These protruding members 312 serve as sound absorbing members, and a passage coming from the cooling fan 20 is sharply bent at an angle of 90° and reduces noise generated when the cooling air hits the first noise reduction part 310.

Specifically, the protruding members 312 allow the cooling air flowing from the inlet duct 200 to spread uniformly through a plurality of hemispherical structures while hitting the upper end of the outlet duct 300 facing the cooling air, that is, the first noise reduction part 310 (see FIG. 4B), thereby being capable of securing vibration robustness of the outlet duct 300.

In addition, the first noise reduction part 310 may be located to be exposed to the passenger space of a first-row seat 1 (see FIGS. 2 and 3), and accordingly, as shown in FIG. 4A, when a passenger on the first-row seat 1 puts his or her feet in the passenger space of the first-row seat 1, the protruding members 312 may serve as beads that minimize changes in the external shape of the outlet duct 300.

The second noise reduction part 320 extends from the first noise reduction part 310, and selectively expands a cross-sectional area to form a second noise reduction section A2 corresponding to the expansion section, thereby preventing mid/low-frequency noise propagation.

Since the expanding structure of the second noise reduction part 320 has an effect of blocking propagation of mid/low-frequency sounds using reflection of sound energy at a discontinuous portion of the cross-section of the second noise reduction part 320, the second noise reduction part 320 provides the expanding structure corresponding to a set maximum cross-sectional area to increase attenuation of mid/low-frequency sounds.

That is, as shown in FIG. 5, the level of the maximum cross-sectional area of front and rear spaces under the first-row seat 1 is limited to 4,000 mm² by surrounding components, such as a plurality of air conditioning ducts 30 including a second-row air conditioning duct located therearound, and a plurality of seat fasteners 50 located inside a side cover 40.

However, a central space under the first-row seat 1 may be expanded in the height direction to be easily secured as a foot space for a passenger seated on a second-row seat 2, and for example, the maximum cross-sectional area of the central space under the first-row seat 1 is set to 16,000 mm² which is four times that of the front and rear spaces, and the second noise reduction section A2 expands to the level of the corresponding cross-sectional area to increase attenuation of the mid/low-frequency sounds.

Since, as the ratio of the cross-sectional area after expansion to the cross-sectional area before expansion increases, the maximum attenuation generally increases, the cross-sectional area of the second noise reduction part 320 forming the second noise reduction section A2 is expanded to 4 times to provide the set maximum attenuation amount in the second noise reduction section A2 corresponding to the central space under the first-row seat 1 based on the front and rear spaces under the first-row seat 1, thereby being capable of attenuating mid/low-frequency sounds in the second sound attenuation section A2 to a decibel (dB) level of about 4 times that of the front and rear spaces.

The third noise reduction part 330 extends from the second noise reduction part 320, and blocks and reduces noise in a frequency band determined depending on structural characteristics of wrinkles 332, including the shape, period, and height of the wrinkles 332, by an acoustic bandgap phenomenon.

The third noise reduction part 330 is located as a third noise reduction section A3 in a passenger space of the second-row seat 2.

As shown in FIG. 6A, the third noise reduction part 330 has a relatively narrow cross-sectional area due to the air conditioning duct 30, the side cover 40, and the passenger space of the second-row seat 2 having a designated length, and accordingly, a flow velocity in the third noise reduction part 330 may relatively increase.

Since, as the flow velocity increases, as described above, the possibility of noise generation is high, a corrugated pipe structure is applied using the passenger space of the second-row seat 2, which has a relatively constant cross-sectional area and extends lengthwise, thereby being capable of inducing the acoustic bandgap phenomenon and accordingly reducing mid/low-frequency noise.

Referring to FIG. 6B, the x-axis indicates the axial direction, the z-axis indicates the heigh direction in the cross section, and h indicates the average height of a two-dimensional duct. In this case, the propagation equation and boundary conditions of sound waves ϕ are given as in Equation 1 below. Here, k is a wave number, kw is a wave number of wall wrinkles 332, ε is an amplitude of the wall wrinkles 332, θ is a phase difference between the upper and lower surfaces of the duct, and rigid body conditions at the boundary are assumed.

$$[ Equation 1 ]$$

$$\frac{{\partial }^{2} ∅}{\partial {x}^{2}} + \frac{{\partial }^{2} ∅}{\partial {z}^{2}} + {k}^{2} ∅ = 0$$

$$( \begin{matrix}z = ϵ h sin ( {k}_{w} x ) : & at z = 0 \\ z = h \{ 1 + ϵ sin ( {k}_{w} x + θ ) \} : & at z = 0 \\ \frac{\partial ∅}{\partial n} = 0 : & at boundaries\end{matrix} )$$

If a change in the amplitude of the wall wrinkles 332 is sufficiently small compared to the height of the duct, a solution may be obtained using the simple perturbation method, and in this case, resonance conditions are expressed as shown in Equation 2 below. In Equation 2, equation (1) indicates that mode m and mode n proceed in opposite directions, and equation (2) indicates that mode m and mode n proceed in the same direction.

$$[ Equation 2 ]$$

$${k}_{m} + {k}_{n} = {k}_{w} \qquad ( 1 )$$

$${k}_{m} - {k}_{n} = {k}_{w} \qquad ( 2 )$$

$$( {k}_{m}^{2} = {k}^{2} - {( \frac{π m}{h} )}^{2} )$$

If the multi-scale perturbation method is used to obtain a stable solution by analyzing the case in which the change in the amplitude of the wall wrinkles 332 is not sufficiently small compared to the height of the duct, the solution of sound waves may be expanded as in Equation 3 below. In Equation 3, x₀ indicates a fast scale representing a wave number related to propagation of sound waves, and x₁ indicates a slow scale representing an amplitude and phase modulation of waves due to resonance, respectively. In Equation, φ₀ and φ₁ are assumed as in Equation 4 below.

$$[ Equation 3 ]$$

$$∅ = {∅}_{0} ( {x}_{0} , {x}_{1} , z ) + {ϵ∅}_{1} ( {x}_{0} , {x}_{1} , z ) + ⋯$$

$$( {x}_{0} = x , {x}_{1} = ϵ x )$$

$$[ Equation 4 ]$$

$${∅}_{0} = {\sum }_{n} {A}_{n} ( {x}_{1} ) cos ( {β}_{n} z ) {e}^{i {k}_{n} {x}_{0}}$$

$${∅}_{1} = {\sum }_{n} {∅}_{n} ( {x}_{1} , z ) {e}^{i {k}_{n} {x}_{0}}$$

$$( {β}_{n} = \frac{π n}{h} , {k}_{n}^{2} = {k}^{2} - {β}_{n}^{2} )$$

Here, if the directions of the modes are opposite (i.e., (1) in Equation 2), a tuning coefficient δ is introduced to set up an equation such as Equation 5 below, only the modes kₘ and kₙ related to resonance are considered and other modes are omitted, and thereafter, when corresponding values are substituted into a governing equation (see Equation 3) and the boundary conditions (see Equation 1) and then these equations are organized with respect to a coefficient A, a differential equation for A may be obtained (a coefficient in this differential equation is set to C). Here, if A is assumed as an exponential function for a variable λ and is substituted into this differential equation, a determinant shown in Equation 6 may be obtained.

$$[ Equation 5 ]$$

$${k}_{m} + {k}_{n} = {k}_{w} + εδ$$

$$[ Equation 6 ]$$

$$( \begin{matrix}i ( λ - δ ) & - {C}_{n m} \\ - {C}_{n m} & i λ\end{matrix} ) ( \begin{matrix}{a}_{m}^{+} \\ {a}_{n}^{-}\end{matrix} ) = ( \begin{matrix}0 \\ 0\end{matrix} )$$

Since the determinant of Equation 6 must be 0 (see Equation 7), when this equation is solved, a solution as in Equation 8 below may be obtained.

$$[ Equation 7 ]$$

$${λ}^{2} - λ δ + {Ω}_{n m} = 0$$

$$( \begin{matrix}{Ω}_{n m} = {H}_{n m} \{ \begin{matrix}{cos}^{2} \frac{θ}{2} ( n + m = odd ) \\ {sin}^{2} \frac{θ}{2} ( n + m = even )\end{matrix} \\ {H}_{n m} = \frac{( {β}_{m}^{2} + {k}_{w} {k}_{m} ) ( {β}_{n}^{2} + {k}_{w} {k}_{n} )}{{k}_{n} {k}_{m}}\end{matrix} )$$

$$[ Equation 8 ]$$

$${λ}_{1 , 2} = \frac{1}{2} ( δ ∓ \sqrt{{δ}^{2} - 4 {Ω}_{n m}} )$$

Assuming kn, km>0, an inequality Ωₙₘ>0 is always satisfied. When λ becomes a complex number in Equation 8, a stopband in which sound waves are physically transmitted and decreased exponentially occurs. Here, a condition in which the stopband occurs, i.e., a condition in which λ becomes a complex number in Equation 8, is given as in Equation 9 below. At this time, in order for the stopband to exist, if θ=π, m+n must be an even number, and if θ=0, m+n must be an odd number. When Equation 5 is applied to the equation indicating this condition, the equation is expanded to an equation that introduces a variable η, and an approximate solution is obtained using the expanded equation, an equation for the stopband may be obtained, as shown in Equation 10 below. In equation 10, c is the speed of sound.

$$[ Equation 9 ]$$

$$\vert δ \vert < 2 \sqrt{{Ω}_{n m}}$$

$$[ Equation 10 ]$$

$${f}_{0} = \frac{{k}_{0} c}{2 π} , {f}_{1 , 2} = \frac{( {k}_{0} ∓ ϵ η )}{2 π}$$

$$Δ f = {f}_{2} - {f}_{1} = \frac{ϵ c η}{π} = \frac{ϵ c {δ}_{0} {k}_{n 0} {k}_{m 0}}{π {k}_{0} ( {k}_{n 0} + {k}_{m 0} )}$$

In Equation 10, f₀ indicates the central frequency of the stopband, f₁ and f₂ indicate the lower and upper limit frequencies of the stopband, and Δf indicates the width of the stopband. From Equation 10, it may be seen that the width Δf of the stopband is proportional to the amplitude & of the wall wrinkles 332. Further, since the tuning efficiency δ (see Equation 5) is related to the wave number k_{w} of the wall wrinkles 332, it may be seen that the width Δf of the stopband is also related to the wave number k_{w} of the wall wrinkles 332. Meanwhile, the above equations are derived assuming that the shape of the wrinkles 332 has the shape of a sine functions, i.e., sinusoidal. Even if the shape of the wall wrinkles 332 is non-sinusoidal (i.e., a triangular shape, a rectangular shape, a wave shape, or the like), this shape may be expressed as a combination of sine functions, and accordingly, the width Δf, lower and upper limit frequencies f₁ and f₂, etc. of the stopband for wall wrinkles having other shapes than the sinusoidal shape may also be obtained using Equation 10.

In summary, according to the theoretical basis as described above, it may be seen that the stopband of sound waves is determined by the shape, period, and height (size) of the wrinkles 332 and the duct height of the third noise reduction part 330 having the wrinkles 332 formed on the inner upper and lower wall surfaces, and the third noise reduction part 330 blocks and reduces noise corresponding to the stopband.

In some implementations, the third noise reduction part 330 may be formed to have a curved surface without edges to reduce fluid noise caused by friction between flowing cooling air and the wrinkles 332. In some implementations, the wrinkles 332 having the above shape may be formed a pair of surfaces facing each other in the vertical direction in the third noise reduction section A3 of the outlet duct 300.

Such a third noise reduction part 330 may be formed so that the structural characteristics of the wrinkles 332 are variable, and more specifically, as shown in FIG. 6C, the period or height of the wrinkles 332 is variable.

In other words, in the third noise reduction section A3, since the length of the passenger space of the second-row seat 2 may vary depending on a vehicle model, if the length of the passenger space of the second-row seat 2 is long, the period of the wrinkles 332 of the applied third noise reduction part 330 may be adjusted to be lengthened or shortened in complex ways, thereby making it possible to respond to various acoustic bandgap phenomena.

In addition, the third noise reduction section A3 may be formed such that the cross-sectional area thereof is repeatedly expanded and contracted due to the left and right side surfaces thereof in a direction in which the cooling air flows, and in more detail, as shown in FIG. 6A, a plurality of groove structures 334 is continuously formed on the left and right side surfaces of the third noise reduction section A3 in the direction in which the cooling air flows so that the cross-sectional area is selectively expanded in areas excluding the groove structures 334, thereby being capable of repeatedly increasing a sound attenuation effect in the areas excluding the groove structures 334 having a relatively large cross-sectional ratio compared to areas including the groove structures 334 based on a similar principle to the above-described second noise reduction section A2.

The fourth sound reduction part 340 extends from the third noise reduction part 330, forms a fourth noise reduction section A4, and includes a head member 342 to distribute the discharge direction and discharge flow rate of the cooling air.

In some implementations, the fourth sound reduction part 340 may be formed to have a large cross-sectional area relative to the third noise reduction part 330.

This allows the fourth noise reduction part 340 to be bent at an angle of 90° from the third noise reduction part 330 to discharge the cooling air toward the wall surface close to the second-row seat 2, and in this case, the fourth noise reduction part 340 may have a relatively expanded cross-sectional area to reduce the flow rate of the discharged cooling air.

In addition, the head member 342 is coupled to a cooling air outlet 340a formed at the end of the fourth noise reduction part 340, and allows the cooling air to be discharged in a distributed manner through a plurality of discharge parts 342a continuously disposed along the edge of the cooling air outlet 340a.

That is, as the head member 342 has a plurality of curved parts 342b, the plurality of discharge parts 342a is formed between the curved parts 342b, respectively, and as shown in FIG. 7B, discharges cooling air in a left and right distributed manner in the direction in which the cooling air is discharged, thereby being capable of distributing the direction and flow rate of the cooling air.

Accordingly, the cooling air is not discharged intensively through the structure of the head member 342 including the discharge parts 342a, and thereby, together with the above-described cross-sectional area expansion structure of the fourth noise reduction part 340 (see FIG. 7A), friction noise that may occur when cooling air passes quickly, airflow noise that occurs when the discharged cooling air hits related parts, such as a seat rail, the wall surface close to the second-row seat 2, etc. may be effectively reduced.

In some implementations, the first noise reduction part 310 to the fourth noise reduction part 340 have been described as being connected sequentially, but this is not fixed, and the first noise reduction part 310 to the fourth noise reduction part 340 may be connected in different orders depending on the interior structure of the vehicle, and a noise reducer may be formed by connecting one or more of the first noise reduction part 310 to the fourth noise reduction part 340.

As described above, in the battery cooling duct for vehicles according to the present disclosure, the battery cooling duct, through which interior air is introduced and discharged, extends to form the plurality of noise reduction sections in the outlet duct, the first noise reduction section connecting the plurality of noise reduction sections to the cooling fan has a plurality of protrusions having a hemispherical shape, the second noise reduction section located under the first-row seat has an expanded cross-sectional area, the third noise reduction section located in the passenger space of the second-row seat is formed in the shape of a corrugated pipe, and the fourth noise reduction section extending from the third noise reduction section to discharge air is formed in a structure including a distributed head, thereby being capable of applying a multi-noise reduction structure to the outlet duct forming the battery cooling passage through the extended first to fourth noise reduction sections.

In addition, the battery cooling duct for vehicles according to the present disclosure is formed in a structure considering the layout with surrounding parts in terms of extension of the first to fourth noise reduction sections, thereby being capable of improving marketability of the outlet duct along with application of the multi-noise reduction structure.

As is apparent from the above description, the present disclosure provides a battery cooling duct for vehicles in which a battery cooling passage, through which interior air is introduced and discharged, extends to form a plurality of noise reduction sections in an outlet duct, a first noise reduction section connecting the plurality of noised reduction sections to a cooling fan has a plurality of protrusions having a hemispherical shape, a second noise reduction section located under a first-row seat has an expanded cross-sectional area, a third noise reduction section located in the passenger space of a second-row seat is formed in the shape of a corrugated pipe, and a fourth noise reduction section extending from the third noise reduction section to discharge air is formed in a structure including a distributed head, thereby being capable of applying a multi-noise reduction structure to the outlet duct forming the battery cooling passage through the extended first to fourth noise reduction sections.

In addition, the battery cooling duct for vehicles according to the present disclosure is formed in a structure considering the layout with surrounding parts in terms of extension of the first to fourth noise reduction sections, thereby being capable of improving marketability of the outlet duct along with application of the multi-noise reduction structure.

The disclosure has been described in detail with reference to example implementations thereof. However, it will be appreciated by those skilled in the art that changes may be made in these implementations without departing from the principles and spirit of the disclosure, the scope of which is defined in the appended claims and their equivalents.

What is claimed is:

1. A battery cooling duct for vehicles, comprising:
a battery case configured to be disposed at a floor panel of a vehicle;
an inlet duct configured to draw cooling air from an interior of the vehicle into a first area of the battery case; and
an outlet duct divided into a plurality of noise reduction parts and configured to guide the cooling air from the first area of the battery case to be discharged to an outside of the outlet duct through a second area of the battery case and the plurality of noise reduction parts, the plurality of noise reduction parts comprising an expansion section.

2. The battery cooling duct of claim 1, wherein the plurality of noise reduction parts comprise:
a first noise reduction part connected to the inlet duct and configured to reduce collision noise of the cooling air entering the first noise reduction part;
a second noise reduction part configured to block mid/low-frequency noise propagation, the second noise reduction part defining the expansion section by expanding a cross-sectional area of the second noise reduction part;
a third noise reduction part comprising wrinkles, the third noise reduction part being configured to reduce noise through an acoustic bandgap phenomenon in a frequency band that is determined by structural characteristics of the wrinkles that include a shape, a period, and a height of the wrinkles; and
a fourth noise reduction part comprising a head member, the head member defining a discharge direction and a discharge flow rate of the cooling air,
wherein one or more of the first to fourth noise reduction parts are connected to one another.

3. The battery cooling duct of claim 2, wherein the first noise reduction part is disposed at a position facing a connection area between the outlet duct and the inlet duct, and
wherein the first noise reduction part comprises a plurality of protruding members that have a hemispherical shape and are continuously arranged along the first noise reduction part.

4. The battery cooling duct of claim 2, wherein the first noise reduction part is configured to be located in a passenger space of a first-row seat of the vehicle.

5. The battery cooling duct of claim 4, wherein the second noise reduction part extends from the first noise reduction part and expands the cross-sectional area of a portion of the second noise reduction part that is disposed under the first-row seat.

6. The battery cooling duct of claim 2, wherein the third noise reduction part is configured to be located in a passenger space of a second-row seat of the vehicle.

7. The battery cooling duct of claim 2, wherein the wrinkles of the third noise reduction part are defined at a pair of surfaces of the third noise reduction part that face each other across an inside of the outlet duct.

8. The battery cooling duct of claim 2, wherein a cross-sectional area of the third noise reduction part is alternately expanded and contracted along a flow direction of the cooling air.

9. The battery cooling duct of claim 2, wherein the structural characteristics of the wrinkles of the third noise reduction part are variable.

10. The battery cooling duct of claim 2, wherein a cross-sectional area of the fourth noise reduction part is greater than a cross-sectional area of the third noise reduction part.

11. The battery cooling duct of claim 2, wherein the outlet duct defines a cooling air outlet at an end of the fourth noise reduction part, and
wherein the head member is coupled to the cooling air outlet.

12. The battery cooling duct of claim 11, wherein the outlet duct comprises a plurality of discharge parts that are continuously arranged along an edge of the cooling air outlet, and
wherein the head member is configured to distribute and discharge the cooling air through the plurality of discharge parts.

13. The battery cooling duct of claim 12, wherein the head member has a plurality of curved parts,
wherein the plurality of discharge parts are disposed between the plurality of curved parts and configured to distribute and discharge the cooling air.

14. The battery cooling duct of claim 1, wherein the outlet duct extends in a direction away from the battery case, and the plurality of noise reduction parts are arranged along the direction away from the battery case, and
wherein the outlet duct has an end that is disposed at a farthest position from the inlet duct and configured to discharge the cooling air to the outside.

15. A battery cooling duct for a vehicle, comprising:
a battery case configured to be disposed at a floor panel of the vehicle;
an inlet duct configured to draw cooling air from an interior of the vehicle into a first area of the battery case; and
an outlet duct divided into a plurality of noise reduction parts and configured to guide the cooling air from the first area of the battery case to be discharged to an outside of the outlet duct through a second area of the battery case and the plurality of noise reduction parts, the plurality of noise reduction parts comprising a wrinkle section.

16. The battery cooling duct of claim 15, wherein the plurality of noise reduction parts comprise:
a first noise reduction part connected to the inlet duct and configured to reduce collision noise of the cooling air entering the first noise reduction part;
a second noise reduction part configured to block mid/low-frequency noise propagation, the second noise reduction part defining an expansion section by expanding a cross-sectional area of the second noise reduction part;
a third noise reduction part comprising the wrinkle section having wrinkles, the third noise reduction part being configured to reduce noise through an acoustic bandgap phenomenon in a frequency band that is determined by structural characteristics of the wrinkles that include a shape, a period, and a height of the wrinkles; and
a fourth noise reduction part comprising a head member, the head member defining a discharge direction and discharge flow rate of the cooling air, and
wherein one or more of the first to fourth noise reduction parts are connected to one another.

17. The battery cooling duct of claim 16, wherein the third noise reduction part is configured to be located in a passenger space of a second-row seat of the vehicle.

18. The battery cooling duct of claim 16, wherein the wrinkles of the third noise reduction part are defined at a pair of surfaces of the third noise reduction part that face each other across an inside of the outlet duct.

19. The battery cooling duct of claim 16, wherein the structural characteristics of the wrinkles of the third noise reduction part are variable.

20. The battery cooling duct of claim 15, wherein the outlet duct extends in a direction away from the battery case, and the plurality of noise reduction parts are arranged along the direction away from the battery case,
wherein the outlet duct has an end that is disposed at a farthest position from the inlet duct and configured to discharge the cooling air to the outside.
